(19) United States
(12) Patent Application Publication
(10) Pub. No.: US 2006/0017194 A1
(43) Pub. Date: Jan. 26, 2006

(54) Mold, manufacturing method of a mold, manufacturing method of a recording medium and a substrate for such a recording medium

(75) Inventor: Sumio Kuroda, Kawasaki (JP)

Correspondence Address: Patrick G. Burns, Esq.;GREER, BURNS & CRAIN, LTD., Suite 2500, 300 South Wacker Drive, Chicago, IL, 60606, US

(73) Assignee: FUJITSU LIMITED

(21) Appl. No.: 11/234,452

(22) Filed: Sep. 23, 2005

Related U.S. Application Data
(62) Division of application No. 09/997,160, filed on Nov. 29, 2001.

(30) Foreign Application Priority Data
May 15, 2001 (JP) 2001-145480

(51) Int. Cl. B29C 33/40

(52) U.S. Cl. 264/219; 65/64; 425/810; 425/385; 249/134; 249/114.1; 264/107

(57) ABSTRACT

In a method of manufacturing a mold for forming an information pattern including servo information or address information on a substrate of a recording medium by being pressed onto the heated substrate, carbon is used as a material for the mold. A mask corresponding to the information pattern is formed on the mold made from carbon of the present invention. Said carbon plate is etched in areas having no mask formed thereon, and lastly the mask is removed.

### BACKGROUND OF THE INVENTION

1. Field of the Invention

The present invention relates to a mold that is pressed onto a substrate of a heated recording medium so as to form an information pattern including servo information or address information on the substrate, a manufacturing method for such a mold, a manufacturing method for such a recording medium, and the substrate.

2. Description of the Related Art

Conventionally, in the case when servo-information or address information is written on a recording medium such as a magnetic disk or an optical disk, a STW (servo track writer) apparatus has been used. However, in recent years, along with an increase in the storing capacity of a recording medium, more time has been required to write the servo information. Moreover, there has been an increase in the number of STW apparatuses required for manufacturing each recording medium. For these reasons, there has been an increase in the manufacturing costs. In order to solve this problem, the applicant of the present invention has proposed a manufacturing method for a recording medium that is disclosed in Japanese Patent Application Laid-Open No. 9-167336/1997. FIGS. 1A and 1B are explanatory drawings that show a cross-sectional view of a conventional recording medium 100 and a servo signal thereof. In FIG. 1B, reference numeral 101 represents a non-magnetic substrate such as a glass substrate. An information pattern corresponding to servo information or address information, etc. is formed on the surface of the substrate 101 through an etching process. A servo layer 102 made of a hard magnetic material, such as CoCr, CoCrPt, CoCrTa or CoNiCr, is embedded in concave portions of this information pattern. Moreover, a magnetic recording layer 103 and a protection film 104, made of the same type of hard magnetic material as the servo layer 102, are stacked on the upper portion of the substrate 101.

FIG. 2 is a perspective view that shows a writing method of a tracking signal onto the recording medium 100. As illustrated in this Figure, the S pole and the N pole of a permanent magnet P are placed along the circumferential direction, and in this state, the recording medium 100 is rotated. Then, the servo layer 102 and the magnetic recording layer 103 on the periphery thereof are magnetized in the same direction (right arrow direction in FIG. 1B) as shown in FIG. 1B. As a result, a magnetic flux indicated by 105 is generated on the surface of the recording medium 100, with the result that servo information or address information is stored in the recording medium 100. In the case when the recording medium 100, finished in this manner, is reproduced by using a magnetic head, not shown, a servo signal as indicated by 106 in FIG. 1A is obtained.

In the above-mentioned method, the substrate itself is etched so as to form an information pattern thereon. In contrast, another method has been proposed in which a mold on which an information pattern is formed has been preliminarily manufactured, and this is pressed onto a substrate that has been heated to a predetermined temperature so that the information pattern is formed on the substrate.

For example, in a method disclosed by Japanese Patent Application Laid-Open No. 4-167226/1992, a super alloy is used as the material of the mold. First, an iridium alloy is formed on the super alloy. This iridium alloy is cut by using a diamond bite. Thus, a mold (stumper) having a groove (truck) formed thereon is prepared. In this method, a glass round plate is interpolated between these stumpers, and heated and pressed, and then cooled to form a glass substrate for a magnetic recording medium.

Moreover, Japanese Patent Application Laid-Open No. 4-95219/1992 has proposed another mold for a magnetic disk substrate in which a super alloy is coated with a noble metal film to form concave and convex portions on the noble metal film, thereby providing a mold.

Furthermore, although not used for forming concave and convex portions, a glass optical element mold, which is coated by a carbon film on a flat mold so as to provide superior separable property to the glass substrate and durability, is disclosed by Japanese Patent Application Laid-Open No. 6-305742/1994.

However, in the method disclosed in Japanese Patent Application Laid-Open No. 9-167336/1997 for etching the substrate itself so as to form an information pattern thereon, the etching process needs to be carried out on each sheet of the substrates, resulting in a problem with manufacturing costs.

Further, in the manufacturing method of a magnetic recording medium-use glass substrate disclosed in Japanese Patent Application Laid-Open No. 4-167226/1992, since the diamond bite is used to form a concave and convex pattern, it is difficult to carry out a precise machining process in the order of sub-micron that is required for optical disks. Therefore, this imposes a fixed limitation on the formation of a complex pattern. For this reason, a method has also been proposed in which Ni is stacked onto a mold made of tungsten carbide with the information pattern being formed on the Ni. However, cracks tend to occur on Ni, causing the cracks to be also transferred, resulting in a failure in transferring the information pattern. Moreover, in the manufacturing method of the magnetic disk substrate-use mold disclosed in Japanese Patent Application Laid-Open No. 4-95219/1992, a method for forming a shallow concave and convex pattern such as texture is disclosed. However, this discloses no formation method of a deep concave and convex pattern used for servo information that the present invention is directed.

Moreover, the glass optical element mold, disclosed in Japanese Patent Application Laid-Open No. 6-305742/1994, is coated by a carbon film on a flat mold so as to provide superior separable property to the glass substrate and durability. However, in the case when the carbon film is coated after the concave and convex pattern has been formed in order to form an information pattern, it is difficult to coat the side faces of the concave or convex portions with the carbon film. In addition, even when coating of the carbon film is made, the coating tends to gradually deteriorate, thereby making the mold difficult to separate and poor in durability.

In other words, in the case when a method for forming an information pattern on the mold is adopted so as to reduce manufacturing costs, first, the mold needs to be capable of precisely forming an information pattern that has become more precise and complex. Second, the mold needs to be capable of easily separating from the substrate after it has been made in press-contact with the substrate under high temperatures. Third, the mold needs to have an improved durability so as to be repeatedly utilized, thereby making it possible to reduce manufacturing costs. There have been demands for a mold that satisfies all the above-mentioned conditions, a manufacturing method for such a mold, a manufacturing method for such a recording medium and such a substrate.

### BRIEF SUMMARY OF THE INVENTION

The present invention has been devised so as to solve the above-mentioned problems.

The objective of the present invention is to provide a mold that is superior in durability and separable property by using carbon as a material of the mold and that is capable of forming more precise information pattern, a manufacturing method of such a mold, a manufacturing method for such a recording medium and such a substrate.

In the present invention, carbon is used as the material of the mold. First, a mask corresponding to an information pattern is formed on a mold made from carbon, and an information pattern is formed by an etching process. Then, the mask is removed. This makes it possible to form a precise, complex information pattern on the carbon. Here, carbon is stable even under the glass transition temperature of the glass substrate and is superior in durability as compared with conventional materials, therefore, it is also possible to reduce manufacturing costs. Moreover, as described earlier, since carbon has a superior separable property, it is possible to form a concave and convex pattern on the substrate more effectively. Furthermore, since the mold itself is made from carbon, no degradation in coating occurs, in comparison with the conventional technique in which the mold is coated with a carbon film.

Moreover, in another arrangement of the present invention, crystalline graphite such as mono-crystal graphite or highly oriented pyrolytic graphite is used as the mold. First, crystalline graphite whose covalent bond surface is formed perpendicularly to a pressing direction is prepared. Then, this is subjected to cleavage so as to expose flat covalent bond surfaces. Thereafter, a mask corresponding to an information pattern is formed thereon and this is subjected to etching. Lastly, the mask is removed. In other words, the crystalline graphite is a plate-shaped crystalline belonging to the hexagonal system, and has extremely high bonding energy exerted on the covalent bond surfaces in the AB surface direction; in contrast, the bonding in the C-axis direction is made by a van der Waals force. Therefore, in the case when crystalline graphite whose covalent bond surface is formed perpendicularly to a pressing direction is etched, the covalent bond surface is always exposed. Consequently, it is possible to obtain a mold having an extremely small surface roughness Ra. Thus, it becomes possible to form a complex information pattern with high precision. In particular, in the case when amorphous carbon is used, the surface roughness tends to have degradation by the etching, however, the present invention makes it possible to provide a mold having surface precision that is far greater than that formed by polishing.

Moreover, in the present invention, a bonding layer such as black lead is interpolated on the rear surface of the etching face of the crystalline graphite plate so that the carbon plate is bonded to form one mold. In other words, with respect to the press contact face to the substrate, the crystalline graphite having a small surface roughness Ra is used. With respect to other portions, inexpensive carbon is used to form one mold. Thus, it is possible to provide a mold having high surface precision at low costs.

Furthermore, in the present invention, first, a resist pattern corresponding to an information pattern is formed on a carbon plate. Then, a metal film such as Al that is less susceptible to etching by oxygen gas, etc. is formed on the carbon plate and the pattern. Successively, the metal film formed on the pattern is lifted off together with the resist. Then, the carbon plate is etched using the metal film formed on the carbon plate as a mask, and lastly, the metal film formed on the carbon plate is removed by NaOH, etc. Thus, by using carbon and metal, it is possible to carry out an etching process with a high etching rate, and consequently to form an abrupt pattern edge. In other words, upon exposing and developing the pattern which is close to diffraction limit size by a mastering device for use in a manufacturing device of an optical disk, edges of resist are formed diagonally. When a dry etching process is carried out in this state, the concave and convex information pattern of the mold is also formed diagonally. Consequently, the concave and convex portions on the substrate, transferred this information pattern thereto, are also formed diagonally, resulting in a problem of a small reproduced waveform of a servo signal, etc. In the present invention, the lifting-off and etching processes are carried out by using a metal film. Thus, it is possible to provide abrupt edges of the concave and convex information pattern, and this arrangement is particularly effective in manufacturing a magnetic disk that requires a magnetic signal with a great amplitude.

Moreover, in the present invention, a resist pattern corresponding to an information pattern is formed on a carbon plate. Then, a second carbon layer is further formed on the carbon plate and the resist pattern. Lastly, the resist is removed together with the second carbon layer formed on the resist by a resist removing agent, etc. With this arrangement, since the exposed carbon plate has a polished surface that has not been subjected to etching, it is possible to obtain a mold having a small surface roughness Ra. In particular, there is an information pattern formed as convex portions in the mold, and since flat portions on the substrate correspond to the bottom of concave portions on the mold, and since these portions are not polished, this arrangement is particularly effective.

Moreover, in the present invention, a metal film is formed on the carbon plate, and a resist pattern corresponding to an information pattern is formed on the metal film. Then, the metal film located in areas on which no resist pattern is formed is subjected to etching. Successively, the carbon plate is etched by using the metal film formed on the carbon plate as a mask, and lastly, the metal film formed on the carbon plate and the mask on the metal film are moved. With the above-mentioned arrangement, it is possible to carry out an etching process having a high etching rate, and consequently to form abrupt pattern edges. In other words, since the etching is executed by using the metal film, it is possible to provide abrupt edges of the concave and convex information pattern, and this arrangement is particularly effective in manufacturing a magnetic disk that requires a magnetic signal with a great amplitude.

Moreover, in the present invention, in the process for forming the resist pattern, exposure is carried out in a state where the carbon plate is fastened on a supporting base of a mastering device by a vacuum chuck, etc. Moreover, with the carbon plate being fastened to the supporting base, the outer or the inner periphery of the carbon plate is cut. Thereafter, a developing process is carried out to form a mask corresponding to the information pattern.

In the case when the outer or the inner periphery is cut so as to form the mold into a shape corresponding to the shape of the substrate after the formation of the mask, that is, after the mask forming process and etching process, the information pattern such as servo information, etc. thus formed might be off-centered. In the case when the off-centered state occurs, the servo information, etc. to be transferred onto the substrate might not be transferred onto a correct position on the substrate. In the present invention, with the carbon plate being fastened on the supporting base of the mastering device, the outer or the inner periphery of the carbon plate is cut. With this arrangement, the pattern information, formed in the mask forming process, is free from the off-centered state; thus it becomes possible to form a mold with high precision, and consequently to manufacture a recording medium with high precision.

Moreover, in the present invention, the substrate of a recording medium is heated to the vicinity of the glass transition point thereof (for example, approximately, 650° C.), and the mold of the first invention or the third invention is made in press-contact with the substrate to form servo information or address information, etc. on the substrate. Thus, in comparison with the conventional method for etching the substrates one by one, it becomes possible to manufacture the recording medium more quickly at lower costs. In addition, since the mold is allowed to have higher durability, it is possible to further reduce the costs.

The above and further objects and features of the invention will more fully be apparent from the following detailed description with accompanying drawings.

### BRIEF DESCRIPTION OF THE SEVERAL VIEWS OF THE DRAWINGS

FIGS. 1A and 1B are explanatory drawings that show a cross-sectional view of a conventional recording medium and a servo signal thereof;

FIG. 2 is a perspective view that shows a method for writing a tracking signal on the recording medium;

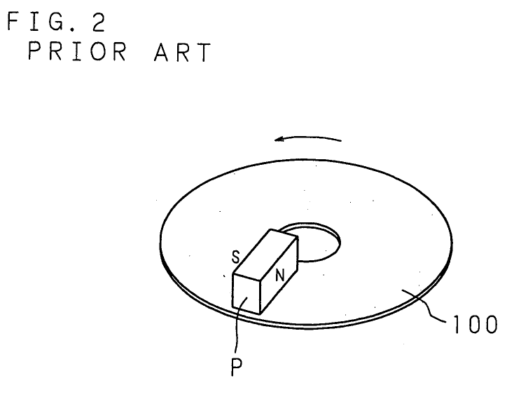

FIGS. 3A to 3E are explanatory drawings that show manufacturing processes of a mold in accordance with the present invention;

FIGS. 4A to 4E are explanatory drawings that show manufacturing processes of a mold in which Si containing resist is used;

FIG. 5 is a plan view of a mold that is manufactured by using a manufacturing method in accordance with the present invention;

FIG. 6 is a perspective view that shows a construction of a heating pressurizer;

FIG. 7 is a cross-sectional view that shows a recording medium;

FIG. 8 is a schematic drawing that shows a crystalline structure of mono-crystal graphite;

FIGS. 9A to 9E are explanatory drawings that show manufacturing processes of a mold in accordance with preferred embodiment 2 of the present invention;

FIGS. 10A to 10C are explanatory drawings that show manufacturing processes of a mold in accordance with preferred embodiment 3 of the present invention;

FIGS. 11A to 11E are explanatory drawings that show manufacturing processes of a mold in accordance with preferred embodiment 4 of the present invention;

FIGS. 12A to 12C are explanatory drawings that show manufacturing processes of a mold in accordance with preferred embodiment 5 of the present invention;

FIGS. 13A to 13E are explanatory drawings that show manufacturing processes of a mold in accordance with preferred embodiment 6 of the present invention; and

FIG. 14 is a schematic drawing that shows a construction of a mastering device.

### DESCRIPTION OF THE PREFERRED EMBODIMENTS

### Preferred Embodiment 1

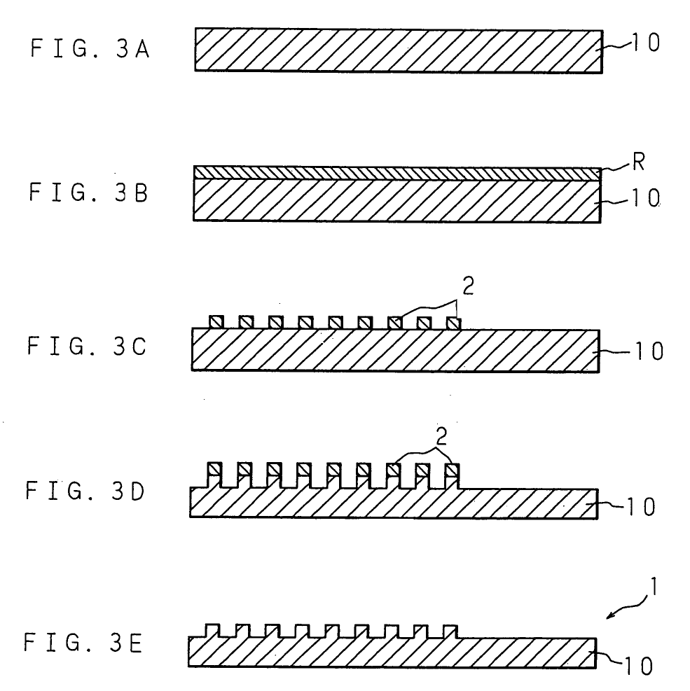

FIGS. 3A to 3E are explanatory drawings that show manufacturing processes of a mold 1 in accordance with the present invention. A carbon plate 10 made from carbon having a thickness of approximately 1 mm is prepared, and the surface of the carbon plate 10 is polished so as to set the surface roughness Ra thereof to not more than 2 nm (FIG. 3A). Here, with respect to the carbon, in addition to amorphous carbon, crystalline graphite, such as mono-crystal graphite or highly oriented pyrolytic graphite, may be used. Then, negative-working electronic beam resist R is applied to the carbon plate 10 by a spin coating method with a thickness of 200 nm, and this is pre-baked (FIG. 3B).

The carbon plate 10 with the pre-baked resist R is placed on a rotary table, not shown. An exposing device (not shown), which exposes the carbon plate 10 by applying an electron beam in an on-off state, while rotating the carbon plate 10, is used to expose portions corresponding to an information pattern such as servo information or address information, etc. After exposure, a developing process is carried out so as to dissolve the unexposed portions by the developing solution, thereby forming a mask 2 on a portion corresponding the information pattern (FIG. 3C). Successively, under an oxygen atmosphere, the carbon plate 10 within the area without the mask 2 formed thereon is etched by RIE (Reactive Ion Etching)(FIG. 3D). In this case, the etching process is carried out for 5 minutes under the conditions of oxygen gas of 15 cc/mmsec and an applied power of 200 W to form an information pattern of approximately 100 nm. Lastly, the mask 2 is removed by a solvent to prepare a mold 1 of the present invention (FIG. 3E).

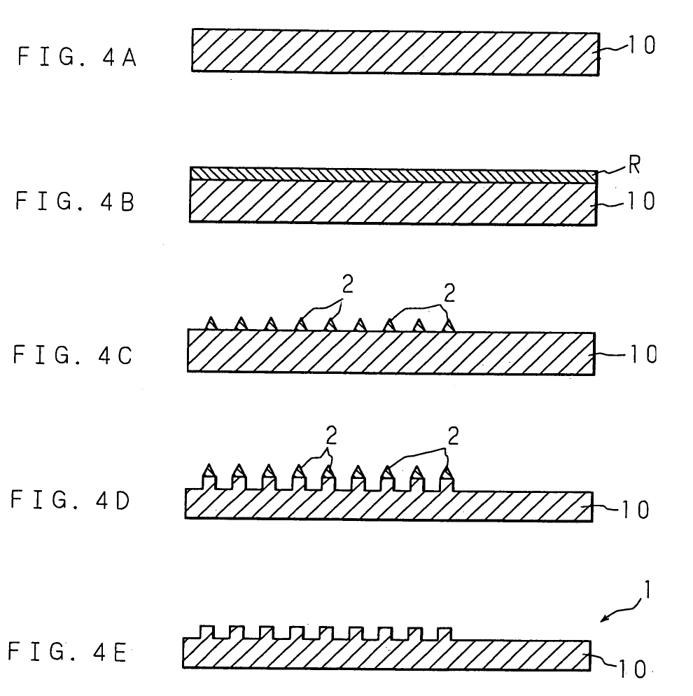

Here, Si containing resist R may be used as the resist R. FIGS. 4A to 4E are explanatory drawings that show manufacturing processes of the mold 1 in the case when the Si containing resist R is used. In the same manner as the above-mentioned processes, a carbon plate 10 is prepared (FIG. 4A), a positive-working Si containing resist R is spin-coated with a predetermined thickness, and this is pre-baked (FIG. 4B). Next, an exposing device using UV light as its light source (different from the above-mentioned exposing device using an electron beam) is used to expose portions corresponding to an information pattern such as servo information or address information, etc. After exposure, a developing process is carried out so that the exposed portion is dissolved by a developing solution; thus, a mask 2 is formed on a portion corresponding to the information pattern (FIG. 4C). In this case, the pattern size is close to diffraction limit, convex portions of the mask 2 are formed slopely.

Successively, under an oxygen atmosphere, the carbon plate 10 within the area without the mask 2 formed thereon is etched by RIE (FIG. 4D). Lastly, the mask 2 is removed by a solvent to prepare a mold 1 of the present invention (FIG. 4E).

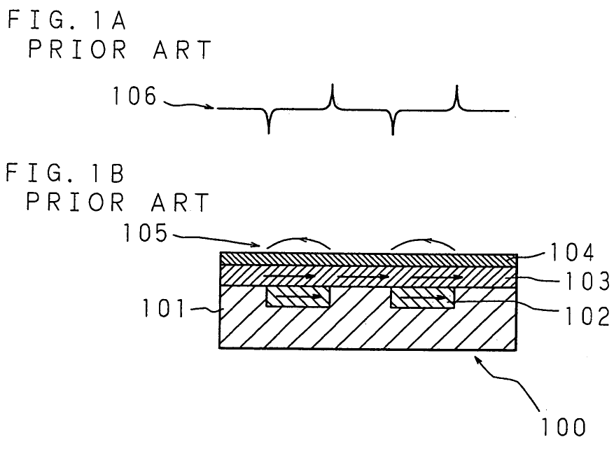

In the case when the Si containing resist R is used, even when oxygen gas is supplied for etching, since this reacts with oxygen to produce SiO2, the Si containing resist R (mask 2) is not etched by oxygen gas thereafter. Consequently, the convex portions of the mold 1 are not formed diagonally, with the result that the concave portions of the substrate 6 to be pressed on these are formed with an acute angle. Thus, it becomes possible to solve the problem of a small reproduced waveform (106 in FIG. 1A) of the servo signal, etc.

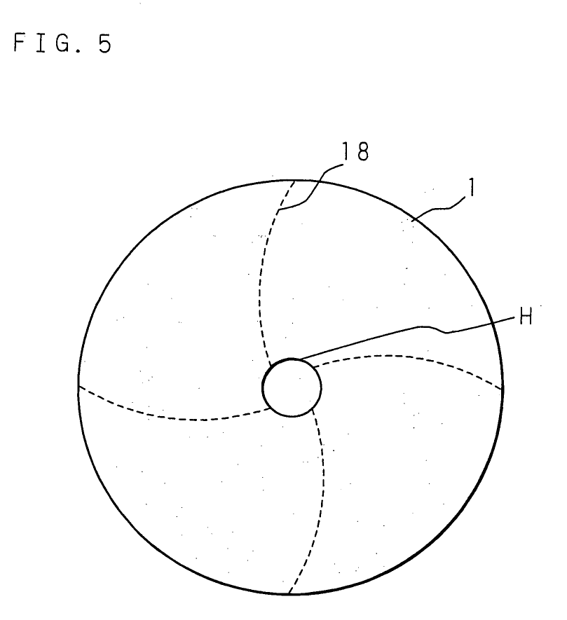

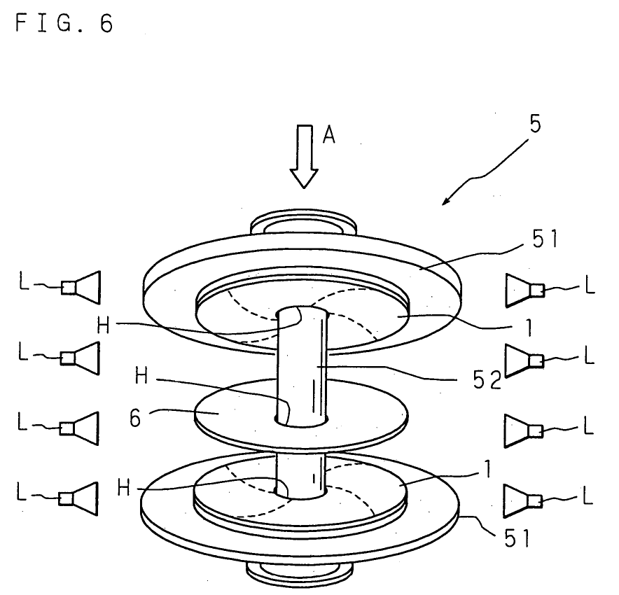

FIG. 5 is a plan view of the mold 1 manufactured by the manufacturing method of the present invention. As illustrated in this Figure, an information pattern 18 of servo information or address information, etc. is formed in the circumferential direction of the mold 1. Moreover, a positioning hole H, which is cut by a YAG laser or bite, is formed in the center of the mold 1. FIG. 6 is a perspective view showing the structure of a heating pressurizer 5. As illustrated in this Figure, molds 1, 1 are set in mold holding members 51, 51 that are placed so as to face each other in the vertical direction of the heating pressurizer 5. Then, a substrate 6 made of soda lime glass, etc., which is interpolated between the molds 1, 1, is pressed thereon so as to transfer the information pattern. In the center of the heating pressurizer 5, a supporting shaft 52 is formed so as to stick out downward in the pressing direction (arrow A). The supporting shaft 52 is allowed to penetrate the positioning hole H of the substrate 6 and the positioning holes H, H of the molds 1, 1. In this manner, the substrate 6 and the molds 1, 1 are set coaxially so that the information pattern is transferred accurately without being off-centered. Here, in the present preferred embodiment, the positioning hole H in the center of the mold 1 and the positioning hole H in the center of the substrate 6 are used to prevent the off-centered state upon forming the information pattern. However, not limited to this arrangement, the off-centered state at the time of the transferring process may be prevented by any appropriate means such as positioning process by using the outer peripheries of the mold 1 and the substrate 6.

In the pressing process, the mold holding members 51, 51 and the molds 1, 1 are heated by using infrared lamps L, L . . . that are placed on the periphery thereof so that the temperature of the substrate 6 is raised to approximately 680° C. Then, the substrate 6 is pressed and molded by applying a pressure of 2·kg cm⁻² from up and down directions. In this case, the molds 1, 1 are maintained for approximately 2 minutes until they have been maintained in parallel with each other with respect to the facing gap. Thereafter, this is cooled with the substrate 6 being pressed until the molds 1, 1 have been set to 580° C. to 630° C., and the molds 1, 1 are then separated from the substrate 6. Here, in order to prevent bubbles from entering the substrate 6, it is preferable to maintain the inside of the heating pressurizer 5 in a vacuum state. Moreover, in the present preferred embodiment, the substrate 6 is pressed from up and down directions, however, of course, this may be pressed in only one direction.

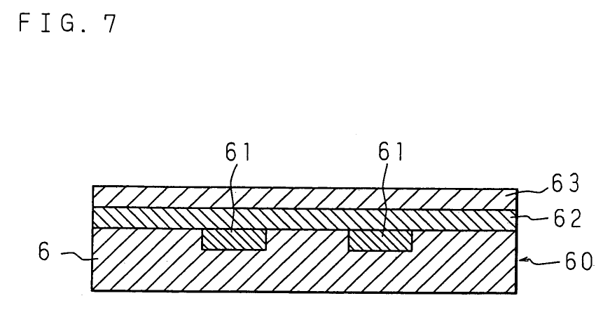

FIG. 7 is a cross-sectional view of a recording medium 60. After the pattern information has been transferred by using the method as described above, a servo layer 61, made of a hard magnetic material such as CoCr, CoCrPt, CoCrTa, or CoNiCr, is embedded in the concave portions of the substrate 6. Next, the substrate 6 and the servo layer 61 are flattened by using a mechanical polishing process, an ion milling process or sputtering. After the flattening process, a magnetic recording layer 62, made of the servo layer 61 and CoCrPt covering the substrate 6, is formed by a sputtering process to have a thickness of 5 to 100 nm, and a protective film 63 is further formed thereon; thus, a recording medium 60 is completed.

### Preferred Embodiment 2

In a manufacturing method of a mold 1 in accordance with preferred embodiment 2, crystalline graphite is used as the material of the mold 1. The following description will discuss a case in which mono-crystal graphite is used as the crystalline graphite; however, highly oriented pyrolytic graphite may be used.

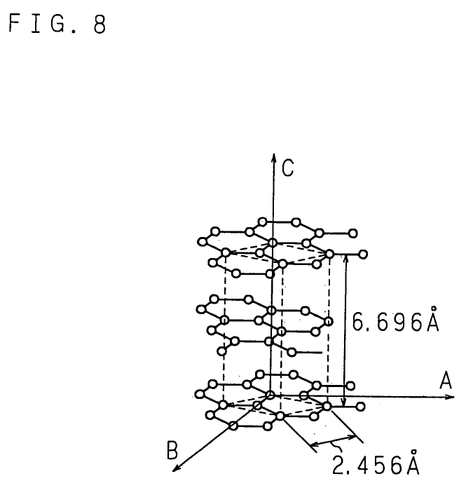

FIG. 8 is a schematic drawing that shows a crystalline structure of mono-crystal graphite. As illustrated in this Figure, mono-crystal graphite, which is a stable plate under a normal pressure at a normal temperature, from a thermo-dynamic point of view, is a plate-shaped crystal belonging to the hexagonal system. The AB face has a covalent bond by a mixed component of sp², and the distance of the C—C bond is 1.42 Å. In contrast, between the covalent bond faces in the C-axis direction, these faces are bonded by a van der Waals force, which is a comparatively weak force.

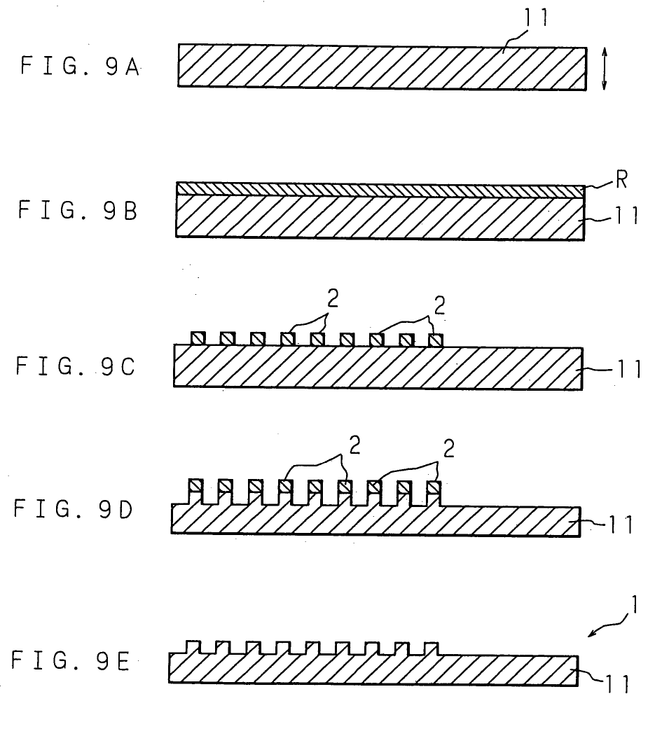

FIGS. 9A to 9E are explanatory drawings that show manufacturing processes of a mold 1 in accordance with preferred embodiment 2 of the present invention. First, a cutting process is carried out so that the covalent bond face (AB face in FIG. 8) of the mono-crystal graphite is set to be perpendicular to the pressing direction (a direction indicated by arrow in FIG. 9) so that a crystalline graphite plate 11 is prepared (FIG. 9A). In other words, cleavage is carried out so that flat covalent bond faces are exposed. Successively, resist R is spin-coated thereon, and this is pre-baked (FIG. 9B).

Then, portions corresponding to the information pattern such as servo information or address information, etc. are exposed by an electron beam exposing device of preferred embodiment 1, not shown. After the exposing process, a developing process is carried out so that unexposed portions are dissolved by a developing solution to form a mask 2 on portions corresponding to the information pattern (FIG. 9C). Successively, under an oxygen atmosphere, the crystalline graphite plate 11 within the area without the mask 2 formed thereon is etched by RIE (FIG. 9D). In this case, the etching process is carried out for 5 minutes under the conditions of oxygen gas of 15 cc/mmsec and an applied power of 200 W to form an information pattern with a depth of approximately 100 nm. Lastly, the mask 2 is removed by a solvent to prepare a mold 1 of the present invention (FIG. 9E).

The preferred embodiment 2 has the arrangement as described above, and the other construction and functions are the same as the preferred embodiment 1; therefore, the corresponding parts are indicated by the same reference numerals, and the detailed description thereof is omitted.

### Preferred Embodiment 3

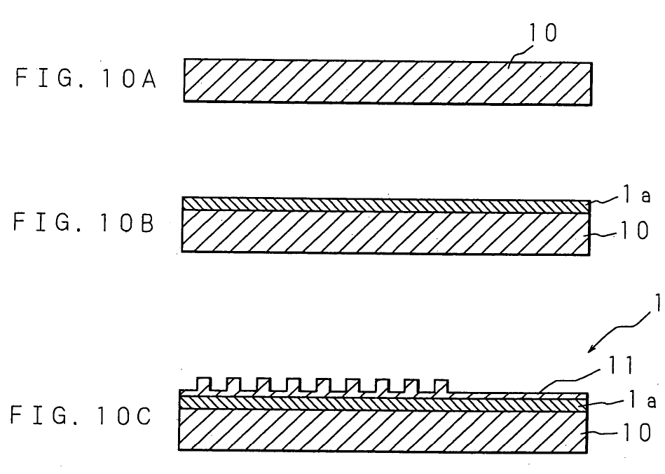

A mold 1 in accordance with preferred embodiment 3 has a laminated structure of a crystalline graphite plate 11 and a carbon plate 10. FIGS. 10A to 10C are explanatory drawings that show manufacturing processes of a mold 1 relating to the preferred embodiment 3. First, inexpensive carbon other than crystalline graphite, for example, amorphous graphite, is used as a material to prepare a carbon plate 10 having a thickness of approximately 1 mm through a sintering process (FIG. 10A). Then, a paste-state bonding layer 1a, made of black lead, etc., applied and formed on the upper portion of the carbon plate 10 with a thickness of 0.01 mm. Next, the crystalline graphite plate 11, formed by the method described in preferred embodiment 2, is stacked on the bonding layer 1a (FIG. 10C). Here, in the case when the crystalline graphite plate 11 is stacked on the bonding layer 1a, it is preferable to stack it after the degree of parallelization of the bonding layer 1a has been obtained.

After stacking the layer, this is baked and solidified at not less than a molding temperature, that is, a temperature at which the concave and convex pattern is to be transferred onto the glass substrate by using the mold 1 (700° C.), to prepare a mold 1 in accordance with preferred embodiment 3. Here, the crystalline graphite plate 11 related to preferred embodiment 2 is formed so as to have a thickness of 1 mm, while the crystalline graphite plate 11 related to preferred embodiment 3 is formed so as to have a thickness of not more than 0.1 mm. In other words, in the case of the mold related to preferred embodiment 3, the laminated structure of a crystalline graphite plate 11 that has a superior surface precision, although it is expensive, and an inexpensive carbon plate 10 is used; therefore, it is possible to further reduce the manufacturing costs. Here, in the present preferred embodiment, the carbon plate 10 is used as the second plate; however, another material may be used as long as it has the same heat resistance as carbon.

### Preferred Embodiment 4

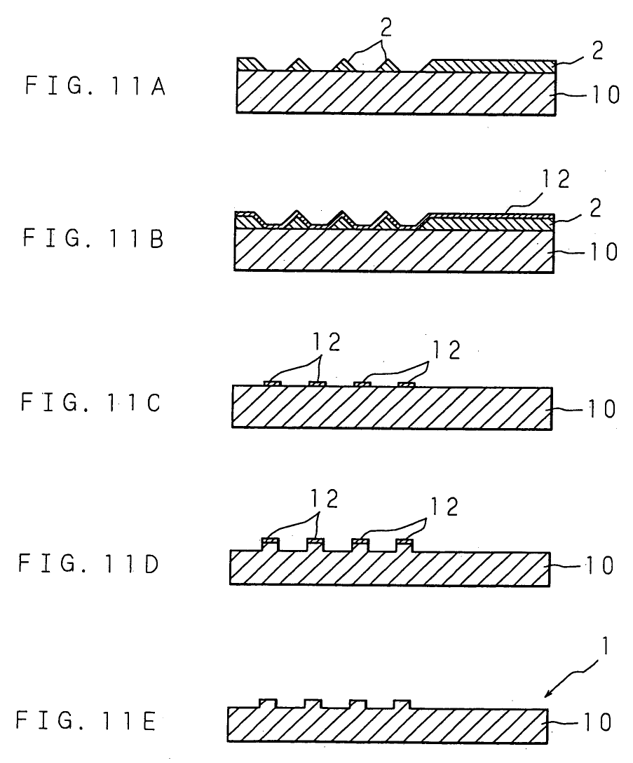

FIGS. 11A to 11E are explanatory drawings that show manufacturing processes of a mold 1 in accordance with preferred embodiment 4 of the present invention. A carbon plate 10, made from carbon having a thickness of approximately 1 mm, is prepared, and the surface of the carbon plate 10 is polished so as to have a surface roughness Ra of not more than 2 nm. Successively, resist R (not shown) having a predetermined thickness (200 nm) is spin-coated, and this is pre-baked. Here, with respect to the carbon, in addition to amorphous carbon, crystalline graphite such as mono-crystal graphite or highly oriented pyrolytic graphite may be used. Then, portions corresponding to information pattern, such as servo information or address information etc., are exposed by a mastering device, not shown. After the exposing process, a developing process is carried out so that the exposed portions are dissolved by a developing solution, thereby forming a mask 2 (resist pattern) corresponding to the information pattern (FIG. 11A).

Next, a metal film 12 such as Al, etc., is formed on the carbon plate 10 and the mask 2 (resist pattern) by vapor deposition or sputtering (FIG. 11B). Here, with respect to the metal film 12, any material may be used as long as it is less susceptible to etching by oxygen gas. Next, a lifting off process is carried out by using a resist separating solution so that the metal film 12 formed on the mask 2 (resist) is removed together with the mask 2 (resist) (FIG. 11c). Successively, under an oxygen gas atmosphere, the carbon plate 10 is etched by RIE using the metal film 12 as a mask (FIG. 1D). In this case, the etching process is carried out for 5 minutes under the conditions of oxygen gas of 15 cc/mmsec and an applied power of 200 W to form an information pattern having a depth of approximately 100 nm. Lastly, the metal film 12 is removed by using NaOH, etc., to prepare a mold 1 of the present invention (FIG. 11E). Here, in the present invention, by using the carbon plate 10 and the metal film 12, it is possible to carry out an etching process having a high etching rate, and consequently to form an abrupt pattern edge.

### Preferred Embodiment 5

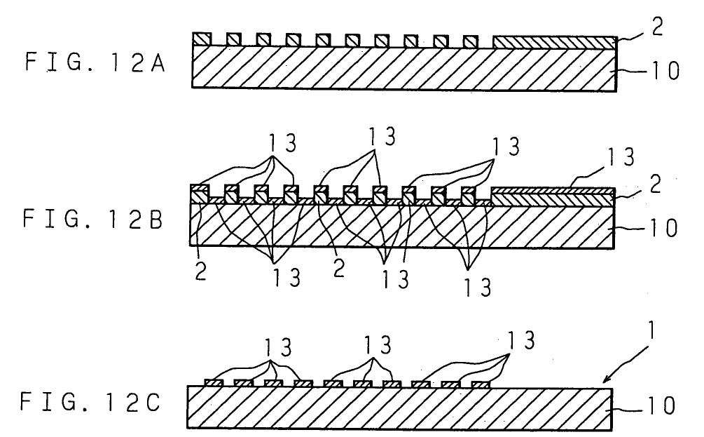

FIGS. 12A to 12C are explanatory drawings that show manufacturing processes of a mold 1 in accordance with preferred embodiment 5 of the present invention. A carbon plate 10 made from carbon having a thickness of approximately 1 mm is prepared, and the surface of the carbon plate 10 is polished so as to set the surface roughness Ra thereof to not more than 2 nm. Successively, resist R (not shown) having an appropriate thickness (200 nm) is spin-coated, and this is pre-baked. Here, with respect to the carbon, in addition to amorphous carbon, crystalline graphite, such as mono-crystal graphite or highly oriented pyrolytic graphite, may be used. Then, portions corresponding to information pattern such as servo information or address information, etc., are exposed by an electron beam exposing device of preferred embodiment 1, not shown. After the exposing process, a developing process is carried out so that unexposed portions are dissolved by a developing solution, thereby forming a resist pattern 2 on portions corresponding to the information pattern (FIG. 12A). Next, a second carbon layer 13 made from carbon is formed by vapor deposition or sputtering (FIG. 12B). Next, a lifting off process is carried out by using a resist separating solution so that the second carbon layer 13 formed on the resist 2 is removed together with the resist 2 to obtain a mold 1 in accordance with the present invention (FIG. 12C).

With this arrangement since the exposed carbon plate 10 has a polished surface that has not been subjected to etching, it is possible to obtain a mold having a small surface roughness Ra. In particular, in the mold 1, there is an information pattern formed as convex portions, and since flat portions on the substrate 6 correspond to the bottom of concave portions on the mold 1, and since these portions are not polished, this arrangement is particularly effective.

### Preferred Embodiment 6

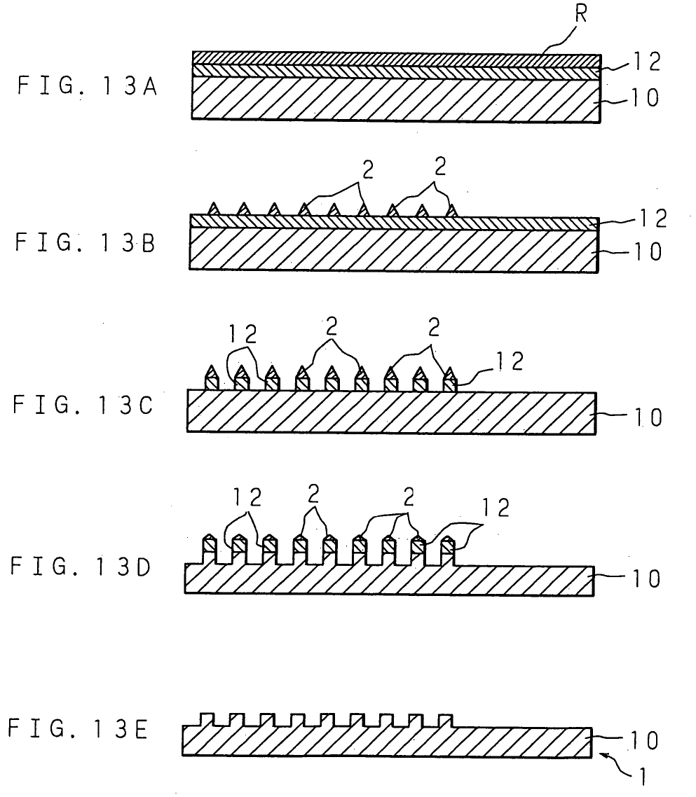

FIGS. 13A to 13E are explanatory drawings that show manufacturing processes of a mold 1 in accordance with preferred embodiment 6 of the present invention. A carbon plate 10 made from carbon having a thickness of approximately 1 mm is prepared, and the surface of the carbon plate 10 is polished so as to set the surface roughness Ra thereof to not more than 2 nm. Next, a metal film 12 made of Al or the like is formed thereon with a thickness of approximately 10 nm by sputtering or the like. After this has been subjected to a coupling process, resist R having a thickness of approximately 200 nm is spin-coated, and this is pre-baked (FIG. 13A). Here, with respect to the carbon, in addition to amorphous carbon, crystalline graphite such as mono-crystal graphite or highly oriented pyrolytic graphite may be used. Then, portions corresponding to information pattern, such as servo information or address information etc., are exposed by a mastering device, not shown. After the exposing process, a developing process is carried out so that the exposed portions are dissolved by a developing solution, thereby forming a mask 2 (resist pattern) corresponding to the information pattern (FIG. 13B).

Next, the metal film 12 located in areas that are not covered with the mask 2 (resist) is etched by using hydrochloric acid (FIG. 13C). Then, under an oxygen gas atmosphere, the carbon plate 10 is etched by RIE (FIG. 13D) using the metal film 12 as a mask. In this case, since the metal film 12 exists, no problem arises with the mask 2 (resist) even when it is simultaneously etched. Lastly, the metal film 12 is removed together with the mask 2 (resist) formed thereon by using NaOH or the like, thereby obtaining a mold 1 (see FIG. 13E). Thus, with the above-mentioned arrangement, it is possible to carry out an etching process having a high etching rate by using the carbon plate 10 and the metal film 12, and consequently to form an abrupt pattern edge.

### Preferred Embodiment 7

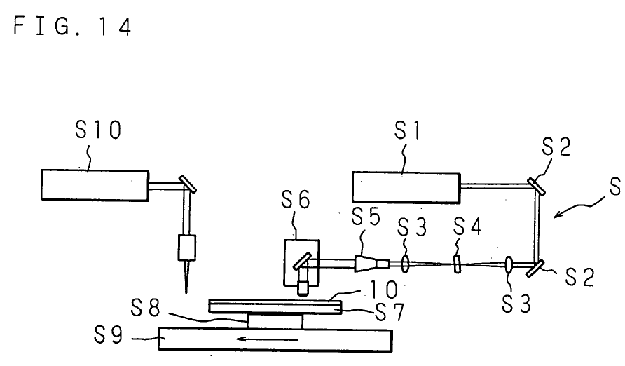

In preferred embodiment 7, an explanation will be given of a process in which the outer or the inner periphery of the carbon plate 10 is cut after the mask forming process. FIG. 14 is a schematic drawing that shows the construction of the mastering device S. As illustrated in this Figure, light emitted from a light source S1 is reflected by reflection mirrors S2, S2. This light is made incident on an optical head S6 composed of a raising mirror and an actuator for focus-controlling an objective lens, after passing through a lens S3, an optical modulation field (AOM) S4, a lens S3 and a beam expander S5. The photoresist (not shown) on the carbon plate 10 is exposed by the incident light. The rear surface of the exposed face of the carbon plate 10 is firmly fastened by a vacuum chuck, etc. onto a supporting base S7. The supporting base S7 is placed on a rotary motor S8, and after the exposure, this is shifted by an air slider S9 in the direction of an arrow in the Figure with the carbon plate 10 being fastened to the supporting base S7. After having been shifted, the outer or the inner periphery of the carbon plate 10 is cut by a cutting device S10 equipped with a YAG laser that is a high-output laser. Here, with respect to the cutting means of the cutting device S10, in addition to the YAG laser, another appropriate means such as a bite may be used. Here, lastly, this is developed to form a mold 1. This arrangement makes it possible to eliminate the off-centered state between the pattern such as servo information and the outer and/or the inner periphery.

Here, not limited to the magnetic disk, the present invention can be applied to the formation of groove or address information of an optical disk. Moreover, the explanation has been given of a method in which an information pattern is formed on a mold; however, the present invention may of course be applied to a method in which: an information pattern is formed on a stamper generally used for manufacturing an optical disk, the stamper is set in a mold, and this is pressed onto a substrate.

As this invention may be embodied in several forms without departing from the spirit of essential characteristics thereof, present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-19. (canceled)

20. A method for fabricating a substrate of a recording medium, comprising:
heating a glass layer; and
pressing a carbon mold on said glass layer to form concave and convex shapes of an information pattern on a surface of said glass layer, said carbon mold having a face including concave and convex shapes corresponding to said concave and convex shapes formed on said glass layer.

21. The method according to claim 20, wherein said information pattern includes servo information or address information.

22. A method according to claim 20, wherein the carbon mold is crystalline graphite whose covalent bond surface is formed perpendicularly to a pressing direction.

23. The method according to claim 20, wherein said carbon mold is manufactured by:
forming a resist pattern corresponding to said information pattern on a carbon plate;
forming a metal film on said carbon plate and said resist pattern;
lifting said resist pattern off said carbon plate together with said metal film formed on said resist pattern;
etching the carbon plate using the metal film formed on said carbon plate as a mask; and
removing the metal film formed on said carbon plate.

24. The method according to claim 20, wherein said carbon mold is manufactured by:
forming a resist pattern corresponding to said information pattern on a carbon plate;
forming a second carbon layer on said carbon plate and said resist pattern; and
removing said resist pattern formed on said carbon plate together with the second carbon layer formed on the resist.

25. The method according to claim 20, wherein said carbon mold is manufactured by:
forming a metal film on a carbon plate;
forming a resist pattern corresponding to said information pattern on said metal film;
etching said metal film in areas on which no resist pattern is formed;
etching said carbon plate using said metal film formed on said carbon plate as a mask; and
removing said metal film and said resist pattern
